(19) United States
(12) Patent Application Publication
(10) Pub. No.: US 2006/0250021 A1
(43) Pub. Date: Nov. 9, 2006

(54) Wire spoke wheel, and components for same

(76) Inventor: Kirk Hoeppner, Mission Viejo, CA (US)

Correspondence Address: LAW OFFICES OF ERIC KARICH, 2807 ST. MARK DR., MANSFIELD, TX, 76063, US

(21) Appl. No.: 11/120,872

(22) Filed: May 3, 2005

(51) Int. Cl. B60B 1/02

(52) U.S. Cl. 301/55

(57) ABSTRACT

A wheel is disclosed including a rim having a pair of spaced apart sidewalls extending outwardly from an annular rim body and having multiple spoke apertures extending therethrough. A hub has a center portion and a generally planar web extending radially from the center portion to a perimeter. A spoke attachment portion positioned at the perimeter has multiple spoke holes extending therethrough. Each of multiple spokes extends between one of the spoke holes and one of the spoke apertures such that the spoke is radially angled sufficiently to cross at least one other spoke. In one embodiment the wheel includes a rim having an annular rim body, a pair of spaced apart sidewalls extending outwardly from the annular rim body, and a pair of flanges each extending laterally from opposed outer edges of the rim body and having multiple spoke apertures extending therethrough.

### CROSS-REFERENCE TO RELATED APPLICATIONS

Not Applicable

### STATEMENT REGARDING FEDERALLY SPONSORED RESEARCH

Not Applicable

### BACKGROUND OF THE INVENTION

1. Field of the Invention

This invention relates generally to wheels for vehicles, and more particularly to wire spoke wheels for vehicles.

2. Description of Related Art

Wire spoke wheels are well known, and a typical wire spoke wheel includes a rim connected to a hub via multiple spokes. Due to their strength and light weight, wire wheels are commonly used on two-wheeled vehicles such as bicycles and motorcycles.

Wire spoke wheels of two-wheeled vehicles are subject to twisting forces in several different directions. For example, when the hub of a wire spoke wheels is driven (e.g., via a chain drive system), a twisting force is created between the hub and the rim in a plane defined by the wheel. Further, steering a two-wheeled vehicle involves leaning the vehicle such that the hub is no longer in vertical alignment with the rim. In this situation, a twisting force is created between the hub and the rim that is perpendicular to the plane defined by the wheel. These and other forces are often present in a wire spoke wheels of two-wheeled vehicles at the same time.

As a result of the forces present in wire spoke wheels, the spokes of wire spoke wheels often break. Each time a spoke breaks, adjacent spokes are subjected to greater loads. In general, when two or more adjacent spokes of a wire spoke wheel break, the wire spoke wheel is in imminent danger of failing.

It would be beneficial to have a wire spoke wheel, and components thereof, that is better able to withstand the forces created within the wire spoke wheel during use.

The following art defines the present state of this field:

E. Ferrabino, U.S. Pat. No. 1,588,957, describes a wire spoke wheel for use automotive vehicles wherein the spokes are arranged in diverging rows with the hub ends of the spokes forming two adjacent rows. The wheel also includes a rim that is attached at the sides of the rim to the spokes.

Chen, U.S. Pat. No. 5,941,606, describes a hub which is configured to have only one flange. The flange is connected to a rim with spokes that are attached to the center of the rim. See also Campagnolo, U.S. Pat. No. 6,036,279.

A. M. Ford, U.S. Pat. No. 1,464,566, describes a metal wheel that includes a hub connected to a rim with a plurality of spokes that are attached to the center of the rim and through a central flange of the hub.

Chen, U.S. Pat. No. 6,070,948, describes a bicycle wheel rim which includes an annular rim body and a plurality of mounting members extending outwardly from the rim. The rim body has an axis, and includes a tire retaining portion which has annular left and right tire retaining walls that are spaced apart from each other. Each of the tire retaining walls has a radial inner edge proximate to the axis of the rim body, and a radial outer edge distal to the axis of the rim body. The spoke mounting member has two opposite lateral outer surfaces, and is formed with a plurality of receiving holes that extend through the lateral outer surfaces and that are distributed along the length of the rim body. The mounting members are received in the receiving holes, respectively. Each of the mounting members has two opposite mounting ends that project from the lateral outer surfaces of the spoke mounting portion. Each of the mounting ends is formed with a spoke mounting hole adapted for mounting a spoke thereon. Similar outwardly extending flanges are shown in A. B. Woggoner, U.S. Pat. No. 607,201, Alberti et al., U.S. Pat. No. 6,145,936,

Other patents of general interest include the following: Chen, U.S. Pat. No. 6,257,677 B1, Chen, U.S. Pat. No. 6,293,629 B1, Herting, U.S. Pat. No. 6,425,641 B1, and Bromley, US Des. 398,691.

The above-described references are hereby incorporated by reference in full.

The prior art teaches various wire spoke wheels. However, the prior art does not teach wire spoke wheels with the advantages described below. The present invention fulfills these needs and provides further related advantages as described in the following summary.

### SUMMARY OF THE INVENTION

A wheel is disclosed including a rim having a pair of spaced apart sidewalls extending outwardly from an annular rim body and having multiple spoke apertures extending therethrough. A hub has a center portion and a generally planar web extending radially from the center portion to a perimeter. A spoke attachment portion positioned at the perimeter has multiple spoke holes extending therethrough. Each of multiple spokes extends between one of the spoke holes and one of the spoke apertures such that the spoke is radially angled sufficiently to triangulate or cross at least one other spoke. In one embodiment the wheel includes a rim having an annular rim body, a pair of spaced apart sidewalls extending outwardly from the annular rim body, and a pair of flanges each extending laterally from opposed outer edges of the rim body and having multiple spoke apertures extending therethrough.

Other features and advantages of the present invention will become apparent from the following more detailed description, taken in conjunction with the accompanying drawings, which illustrate, by way of example, the principles of the invention.

### BRIEF DESCRIPTION OF THE DRAWING

The accompanying drawings illustrate the present invention. In such drawings:

FIG. 1 is a perspective view of one embodiment of a wire spoke wheel including a rim connected to a hub via multiple spokes;

FIG. 2A is a cross sectional view of the wheel of FIG. 1 as indicated in FIG. 1;

FIG. 2B is a side view of a portion of the wheel of FIG. 1;

FIG. 3 is a perspective view of one embodiment of the hub of the wheel of FIG. 1;

FIG. 4 is a perspective view of a portion of the wheel of FIG. 1 illustrating another embodiment of the hub;

FIG. 5 is a cross sectional view of a portion of the hub of FIG. 4 as indicated in FIG. 4; and

FIG. 6 is a cross sectional view of a portion of the wheel of FIG. 1 illustrating another embodiment of the rim.

### DETAILED DESCRIPTION OF THE INVENTION

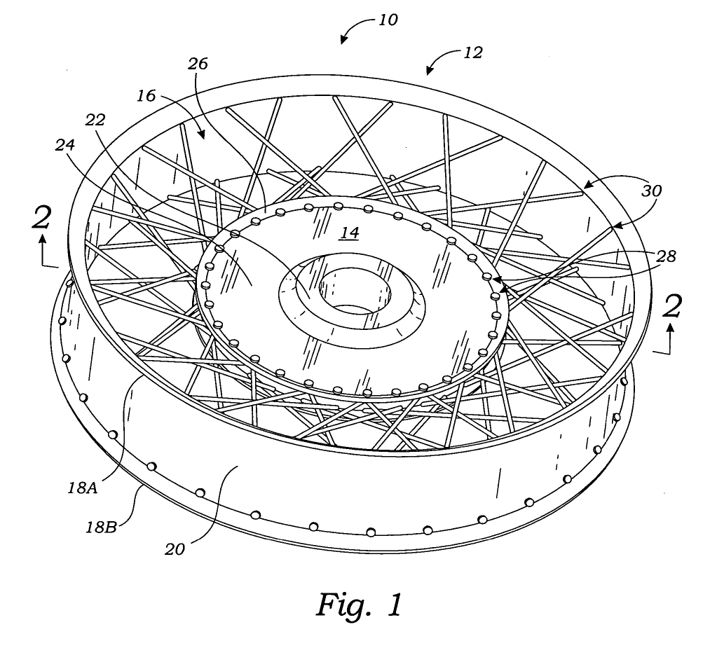

FIG. 1 is a perspective view of one embodiment of a wire spoke wheel 10 including a rim 12 connected to a hub 14 via multiple spokes 16. In the embodiment of FIG. 1, the rim 12 has a pair of spaced apart sidewalls 18A and 18B extending outwardly from an annular rim body 20. The annular rim body 20 and the pair of spaced apart sidewalls 18A and 18B are adapted to receive a tire.

In the embodiment of FIG. 1, the hub 14 has a center portion 22, a generally planar web 24 extending radially from the center portion 22 to a perimeter of the hub 14, and a spoke attachment portion 26 positioned at the perimeter of the hub 14. The center portion 22 is generally adapted to receive wheel bearings and an axle. The spoke attachment portion 26 has multiple spoke holes 28 extending therethrough, and multiple spoke apertures 30 extend through the rim body 20. In general, each of the spokes 16 extend between one of the spoke holes 28 of the spoke attachment portion 26 of the hub 14 and one of the spoke apertures 30 of the rim body 20.

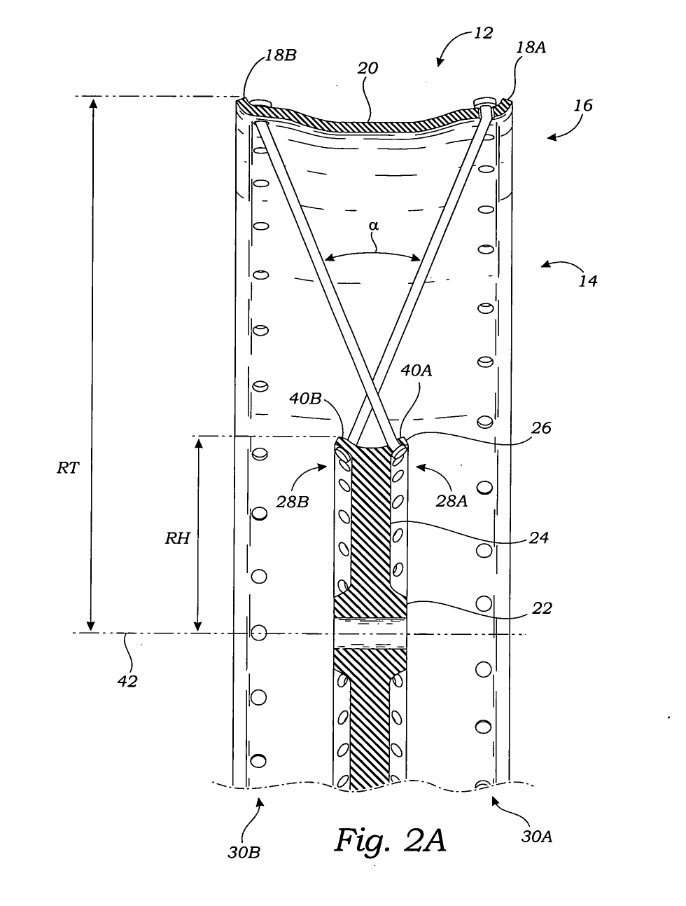

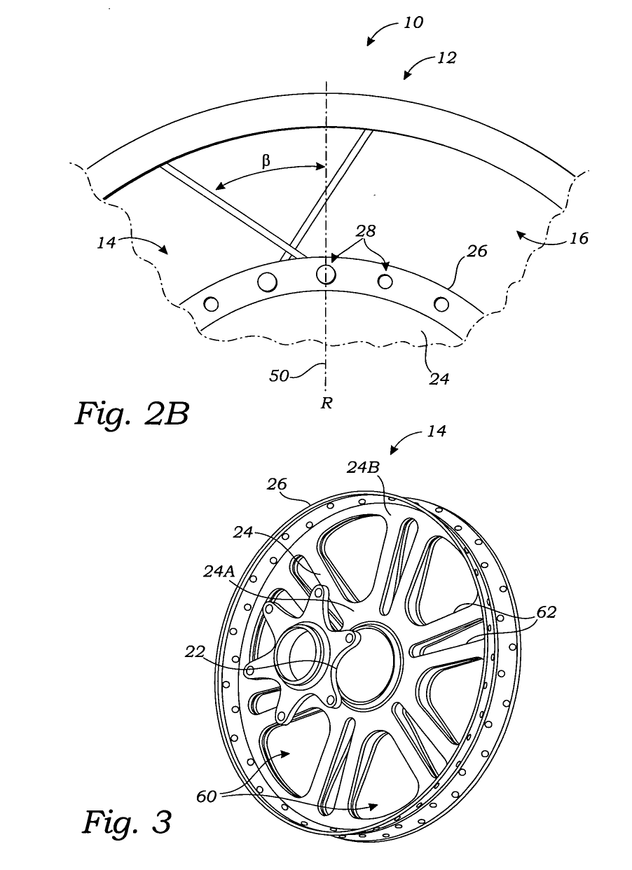

In the embodiment of FIG. 1, the spoke apertures 30 of the rim body 20 are arranged to form two circular rows, wherein each row is adjacent a different one of the sidewalls 18A and 18B of the rim 12. The spoke attachment portion 26 of the hub 14 has two divergent flanges. (See FIG. 2A.) The spoke holes 28 of the spoke attachment portion 26 of the hub 14 are arranged to form two circular rows, and wherein each of the rows is located in a different one of the flanges.

As described in more detail below, each of the spokes 16 is radially angled sufficiently to cross at least one other spoke 16. This patterning of the spokes 16 is referred to as “semi-tangent” as the spokes 16 leave the spoke attachment portion 26 of the hub 14 at angles somewhat resembling tangents. This crossed patterning of the spokes 16 enables the spokes 16 to better withstand twisting forces existing between the rim 12 and the hub 14 in a plane defined by the web 24.

In the embodiment of FIG. 1, the web 24 of the hub 14 divides the wheel 10 into two opposed sides. Each of the spokes 16 has one end positioned in one of the spoke holes 28 of the spoke attachment portion 26 of the hub 14 on one side of the wheel, and an opposite end positioned in one of the spoke apertures 30 of the rim body 20 of the rim 12 on the opposite side of the wheel 10. This connecting of the spokes 16 between the opposite sides of the wheel 10 enables the spokes 16 to better withstand twisting forces existing between the rim 12 and the hub 14 that are perpendicular to the plane defined by the web 24. In addition, spokes 16 having ends positioned in adjacent ones of the spoke holes 28 of the spoke attachment portion 26 are paired, and paired spokes 16 cross each other. (See FIG. 2B.) This crossed patterning of the spokes 16 enables the spokes 16 to better withstand twisting forces existing between the rim 12 and the hub 14 in the plane defined by the web 24.

The rim 12 is preferably made of extruded aluminum. For example, semi-molten aluminum may be extruded through an opening which defines a cross section of the rim 12. The resulting extrusion may be formed into a hoop, and ends of the hoop may be joined together (e.g., by welding). Alternately, the rim 12 may be made of steel, and may be plated or coated with a corrosion resistant material such as chrome or zinc.

The hub 14 is preferably made of aluminum, and more preferably made of forged aluminum. For example, the hub 14 may be machined or milled from a solid piece of forged aluminum. Alternately, the hub 14 may be made of steel, and may be plated or coated with a corrosion resistant material such as chrome or zinc.

The spokes 16 are preferably made of stainless steel. Alternately, the spokes 16 may be made of steel, and may be plated or coated with a corrosion resistant material such as chrome or zinc. As described above, the wheel 10 may be formed in the conventional fashion by providing the rim 12, the hub 14, and the spokes 16, lacing the spokes 16 to form the desired spoke patterning, and tensioning the spokes 16 to true the wheel 10.

FIG. 2A is a cross sectional view of the wheel 10 of FIG. 1 as indicated in FIG. 1. As described above, the spoke apertures 30 of the rim body 20 are arranged to form two circular rows 30A and 30B. As shown in FIG. 2A, the row 30A is adjacent the sidewall 18A of the rim 12, and the row 30A is adjacent the sidewall 18B. In FIG. 2A, the two divergent flanges of the spoke attachment portion 26 of the hub 14 are labeled 40A and 40B. The spoke holes 28 of the spoke attachment portion 26 of the hub 14 are arranged to form two circular rows 28A and 28B. As shown in FIG. 2A, the row 28A is located in the flange 40A, and the row 28B is located in the flange 40B.

In FIG. 2A, a distance from an axis 42 of the center portion 22 of the hub 14 to a perimeter of the spoke attachment portion 26 the hub 14 defines a radius of the hub “RH,” and a distance from the axis 42 to a portion of the rim body 20 of the rim 12 adjacent the sidewall 18B of the rim 12 defines a total radius “RT.” In one embodiment, RH is greater than or equal to (RT/3), and RH is greater than (RT−RH).

As described above, the web 24 of the hub 14 divides the wheel 10 into two opposed sides. As shown in FIG. 2A, each of the spokes 16 has one end positioned in one of the spoke holes 28 of the spoke attachment portion 26 of the hub 14 on one side of the wheel, and an opposite end positioned in one of the spoke apertures 30 of the rim body 20 of the rim 12 on the opposite side of the wheel 10. That is, every spoke 16 having an end positioned in one of the spoke holes 28 in the row 28B in the flange 40B of the spoke attachment portion 26 has an opposite end positioned in one of the spoke apertures 30 in the row 30A adjacent the sidewall 18A of the rim 12 on an opposite side of the wheel 10. Similarly, every spoke 16 having an end positioned in one of the spoke holes 28 in the row 28A in the flange 40A of the spoke attachment portion 26 has an opposite end positioned in one of the spoke apertures 30 in the row 30B adjacent the sidewall 18B of the rim 12 on an opposite side of the wheel 10.

In general, each of the spokes 16 has an end positioned in one of the spoke holes 28 of the spoke attachment portion 26 of the hub 14 and an opposite end positioned in one of the spoke apertures 30 of the rim body 20 of the rim 12. As indicated in FIG. 2A, an angle “α” is formed between two adjacent spokes 16 having ends positioned in spoke holes 28 in different ones of the flanges 40A and 40B of the spoke attachment portion 26 of the hub 14. That is, the angle α is formed between two adjacent spokes 16 having ends positioned in spoke holes 28 on opposite sides of the wheel 10. In general, the angle α is greater than 25 degrees, and preferably greater than 30 degrees, and most preferably greater than 40 degrees. In addition to providing tremendous lateral strength to the wheel 10, this large angle “α” is also important when building the wheel. Traditional wheels that include spokes attached to the center of the rim enable good control over the radial run out of the wheel, but very little control over the lateral run out of the rim. Many of the new wheel designs, which pull from an edge of a hub to an opposite edge of the rim, forming an “X”, provide lateral strength, but it is very difficult to control both lateral and radial run out, as the two goals are often difficult to synchronize. Indeed, it is generally necessary to use a jig to correctly build the wheel, so difficult is the job.

In the present wheel 10, however, the two forces are synchronized. By pulling from the center of the hub and the outer edges of the rim, with a large angle “α”, the builder of the wheel 10 is given unprecedented control over both the lateral and radial run out. The wheel 10 provides tremendous lateral strength, but can still be built by hand without the use of a jig or similar special tool.

FIG. 2B is a side view of a portion of the wheel 10 of FIG. 1. In FIG. 2B, two of the spokes 16 are shown. The two spokes 16 have ends positioned in adjacent spoke holes 28 of the spoke attachment portion 26. As described above, the two spokes 16 are paired. As illustrated in FIG. 2B, paired spokes 16 cross each other.

In FIG. 2B, a radial line 50 extends radially outward from a center of the center portion 22 of the hub 14 (see FIG. 1) and passes through one of the spoke holes 28 of the spoke attachment portion 26. As shown in FIG. 2B, the spoke 16 having an end in the spoke hole 28 forms an angle “β” with respect to the radial line 50. In general, the angle β is at least 10 degrees, and is more preferably at least 30 degrees, and is most preferably about 45 degrees.

FIG. 3 is a perspective view of one embodiment of the hub 14 of the wheel 10 of FIG. 1. In the embodiment of FIG. 3, the web 24 of the hub 14 has multiple openings 60 such that an inner portion 24A of the web 24 is connected to an outer portion 24B of the web 24 via multiple spaced apart linear structures 62 extending radially between the inner portion 24A and the outer portion 24B of the web 24. In the embodiment of FIG. 3, the linear structures 62 resemble spokes of a wheel.

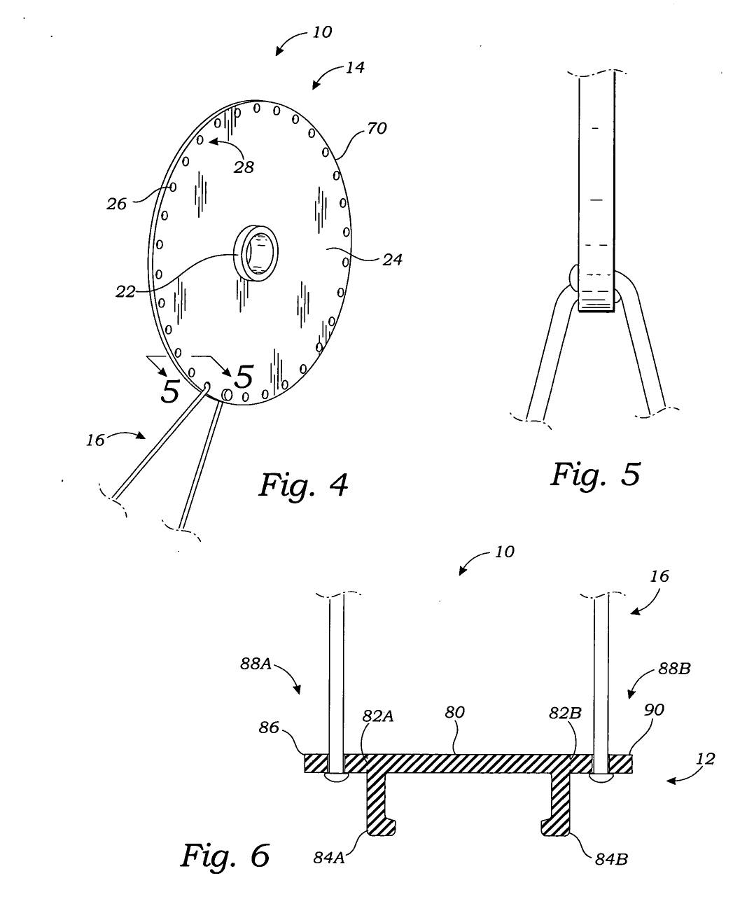

FIG. 4 is a perspective view of a portion of the wheel 10 of FIG. 1 illustrating another embodiment of the hub 14. In the embodiment of FIG. 4, the spoke attachment portion 26 has a single flange 70, and the spoke holes 28 of the spoke attachment portion 26 are arranged to form a circular row in the flange 70. In FIG. 4, two of the spokes 16 are shown having ends positioned in adjacent spoke holes 28. The two spokes 16 extend from opposite sides of the flange 70. FIG. 5 is a cross sectional view of a portion of the hub 14 of FIG. 4 as indicated in FIG. 4.

FIG. 6 is a cross sectional view of a portion of the wheel 10 of FIG. 1 illustrating another embodiment of the rim 12. In the embodiment of FIG. 6, the rim 12 includes an annular rim body 80 having opposed outer edges 82A and 82B and a pair of spaced apart sidewalls 84A and 84B extending outwardly from the rim body 80. A first flange 86 extends laterally from the outer edge 82A of the rim body 80, and has multiple spoke apertures 88A extending therethrough. A second flange 90 extends laterally from the outer edge 82B of the rim body 80, and has multiple spoke apertures 88B extending therethrough. The spoke apertures 88A are arranged to form a first circular row adjacent the outer edge 82A of the rim body 80, and the spoke apertures 88B form a second circular row adjacent the outer edge 82B of the rim body 80. The rim body 80 and the sidewalls 84A and 84B are adapted to receive a tire (e.g., a tubeless tire).

In general, the spoke apertures 88A and 88B in combination make up spoke apertures 88 formed in the rim body 80. Each of the spokes 16 extend between one of the spoke holes 28 of the spoke attachment portion 26 of the hub 14 (FIG. 1) and one of the spoke apertures 88 of the rim body 80.

While the invention has been described with reference to at least one preferred embodiment, it is to be clearly understood by those skilled in the art that the invention is not limited thereto. Rather, the scope of the invention is to be interpreted only in conjunction with the appended claims.

What is claimed is:

1. A wheel, comprising:
a rim having a pair of spaced apart sidewalls extending outwardly from an annular rim body, the annular rim body and the pair of spaced apart sidewalls being adapted to receive a tire;
a plurality of spoke apertures extending through the annular rim body;
a hub comprising a center portion, a generally planar web extending radially from the center portion to a perimeter, and a spoke attachment portion positioned at the perimeter and having a plurality of spoke holes; and
a plurality of spokes each extending between one of the spoke holes of the spoke attachment portion of the hub and one of the spoke apertures of the annular rim body such that each of the spokes is radially angled sufficiently to cross at least one other of the plurality of spokes.

2. The wheel as recited in claim 1, wherein a distance from an axis of the center portion of the hub to a perimeter of the spoke attachment portion the hub defines a radius of the hub RH, and wherein a distance from the axis of the center portion of the hub to a portion of the rim body of the rim adjacent one of the sidewalls of the rim defines a total radius RT.

3. The wheel as recited in claim 2, wherein RH is greater than or equal to (RT/3).

4. The wheel as recited in claim 2, wherein RH is greater than or equal to (RT/2).

5. The wheel as recited in claim 1, wherein the web of the hub divides the wheel into two opposed sides, and wherein each of the spokes has one end positioned in one of the spoke holes of the spoke attachment portion of the hub on one side of the wheel, and an opposite end positioned in one of the spoke apertures of the rim body of the rim on the opposite side of the wheel.

6. The wheel as recited in claim 5, wherein an angle formed between two adjacent spokes having ends positioned in spoke holes of the spoke attachment portion of the hub on opposite sides of the wheel is greater than 25 degrees.

7. The wheel as recited in claim 5, wherein an angle formed between two adjacent spokes having ends positioned in spoke holes of the spoke attachment portion of the hub on opposite sides of the wheel is greater than 30 degrees.

8. The wheel as recited in claim 1, wherein each of the spokes has an end positioned in one of the spoke holes of the spoke attachment portion of the hub and an opposite end positioned in one of the spoke apertures of the rim body of the rim.

9. The wheel as recited in claim 8, wherein spokes having ends positioned in adjacent ones of the spoke holes of the spoke attachment portion of the hub are paired, and wherein paired spokes cross each other.

10. The wheel as recited in claim 9, wherein each of the paired spokes crosses a radial line at an angle of at least 10 degrees.

11. The wheel as recited in claim 9, wherein each of the paired spokes crosses a radial line at an angle of at least 30 degrees.

12. The wheel as recited in claim 1, wherein the web comprises a plurality of openings such that an inner portion of the web is connected to an outer portion of the web via a plurality of spaced apart linear structures extending radially between the inner and outer portions of the web.

13. A rim for a wheel, comprising:
an annular rim body having opposed outer edges;
a pair of spaced apart sidewalls extending outwardly from the annular rim body;
a pair of flanges each extending laterally from one of the opposed outer edges of the annular rim body and having a plurality of spoke apertures extending therethrough; and
wherein the annular rim body and the pair of spaced apart sidewalls are adapted to receive a tire.

14. The rim as recited in claim 13, wherein the apertures are arranged to form two circular rows, and wherein each row is adjacent a different one of the outer edges of the annular rim body.

15. The rim as recited in claim 13, wherein the sidewalls are adapted to receive a tubeless tire.

16. A wheel, comprising:
a rim, comprising:
an annular rim body having opposed outer edges;
a pair of spaced apart sidewalls extending outwardly from the annular rim body;
a pair of flanges each extending laterally from one of the opposed outer edges of the annular rim body and having a plurality of spoke apertures extending therethrough;
wherein the annular rim body and the pair of spaced apart sidewalls are adapted to receive a tire;
a hub comprising a center portion and a generally planar web extending radially from the center portion to a perimeter, the perimeter having a spoke attachment portion having a plurality of spoke holes; and
a plurality of spokes each extending between one of the spoke holes of the spoke attachment portion of the hub and one of the spoke apertures of one of the pair of flanges of the rim.

17. The wheel as recited in claim 16, wherein a distance from an axis of the center portion of the hub to a perimeter of the spoke attachment portion the hub defines a radius of the hub RH, and wherein a distance from the axis of the center portion of the hub to a portion of the rim body of the rim adjacent one of the sidewalls of the rim defines a total radius RT.

18. The wheel as recited in claim 16, wherein RH is greater than or equal to (RT/3).

19. The wheel as recited in claim 16, wherein RH is greater than or equal to (RT/2).

20. The wheel as recited in claim 16, wherein the web of the hub divides the wheel into two opposed sides, and wherein each of the spokes has one end positioned in one of the spoke holes of the spoke attachment portion of the hub on one side of the wheel and an opposite end positioned in one of the spoke apertures of the rim body of the rim on the opposite side of the wheel.
